(19) United States
(12) Patent Application Publication
(10) Pub. No.: US 2012/0327675 A1
(43) Pub. Date: Dec. 27, 2012

(54) LIGHTING ASSEMBLY OF A VEHICLE

(75) Inventors: Pranay Kumar Bajjuri, Fort Wayne, IN (US); John Jacob, Fort Wayne, IN (US)

(73) Assignee: International Truck Intellectual Property Company, LLC, Warrenville, IL (US)

(21) Appl. No.: 13/166,233

(22) Filed: Jun. 22, 2011

(51) Int. Cl. B60Q 1/56; B60Q 1/26

(52) U.S. Cl. 362/497; 362/487

(57) ABSTRACT

A lighting assembly has a first array of lamp elements to a first side of a central zone and a second array of lamp elements to a second side of the central zone. Each array has at least one low intensity lamp element operable to cause the lighting assembly to present a low intensity brightness to an observer viewing the lighting assembly and at least one high intensity lamp element operable to cause the lighting assembly to present a high intensity brightness to an observer viewing the lighting assembly, and an electrical connector through which electric current is fed to operate the lamp elements.

### TECHNICAL FIELD

This disclosure relates to a lighting assembly of a vehicle, such as a land vehicle, a water vehicle or an air vehicle.

### BACKGROUND

Illustrating by example, land vehicles which operate on roads and highways have tail lighting which comprises various arrangements of lamps which perform various lighting functions. Certain laws and regulations applicable to motor vehicles operating in the United States may specify certain requirements for tail lighting functions.

Typical tail lighting functions include: a tail light function; a stop light function; a right turn signal light function; a left turn signal light function; and a back-up light function. A tail lighting construction in some vehicles may also provide for a tail light to be seen from a side of a vehicle and thereby also function as a side marker light at the rear of a vehicle.

An example of typical tail lighting comprises a separate right tail light assembly and a separate left tail light assembly mounted on respective right and left sides of a vehicle at a vehicle's rear. Such assemblies typically provide stop light, turn signal light, and tail light functions. Back-up lights may be included with the tail light assemblies, or else may comprise one or more individual assemblies separately mounted on the vehicle, for providing a reverse, or back-up, indicating function.

When a headlamp or running lamp switch is turned on, tail lamps illuminate on right and left sides of a vehicle to present relatively less intense red light to an observer. When a brake pedal is depressed to decelerate a moving vehicle and in the process operate a stop lamp switch, stop lamps on right and left sides illuminate to present red light which has a greater intensity than that of a tail lamp. When a right turn signal switch is turned on, a right turn signal lamp on the right side intermittently illuminates (i.e. flashes) to present red light more intense than that of a tail lamp. When a left turn signal switch is turned on, a left turn signal lamp on the left side intermittently illuminates to present red light relatively more intense than that of a tail lamp. When a back-up switch is turned on by placement of the vehicle drivetrain in a reverse drive gear, one or more reverse, or back-up, lamps illuminate to present non-red light, typically colorless.

Certain lamps may be capable of performing more than one function.

For one example, certain lamps may be capable of functioning as a tail light and as a stop light. If the brake pedal is not depressed while a headlamp or running lamp switch is on, such a lamp will illuminate as a tail light. When the brake pedal is depressed, the stop lamp switch will cause the lamp to illuminate with greater intensity to indicate that the vehicle is decelerating.

For another example, certain lamps may be capable of functioning as a stop light and as a turn signal light. If a turn signal switch is operated to signal either a right turn or a left turn, such a lamp will begin to flash with greater intensity that of a tail lamp, and if the brake pedal is being concurrently depressed, the turn signal light function overrides the stop light function so that the combination stop/turn signal lamp on that side continues to flash while the corresponding one on the opposite side remains continuously illuminated.

When an emergency warning switch is turned on, it will cause right and left lamps, which flash independently to give respective right and left turn signals, to flash in unison.

In certain motor vehicles, such as large trucks, right and left tail light assemblies are mounted on right and left ends of a chassis frame cross-member which extend between right and left chassis frame siderails at the vehicle rear.

### SUMMARY OF THE DISCLOSURE

This disclosure introduces a lighting assembly which when used as a tail lighting assembly of a vehicle comprises a tail lighting module spanning right and left sides of a vehicle at the vehicle's rear. The illustrated module comprises an array of lamp elements which provide a tail light function, a stop light function, a right turn signal light function, a left turn signal light function, and a back-up light function.

Another part of the tail lighting assembly is a license plate mounting which extends vertically downward from a central portion of the tail lighting module between right and left ends of the module to present an exterior rear face to which a vehicle license plate can be fastened. When a headlamp or running lamp switch is operated to illuminate tail lamp elements, one or more lamp elements shine light on an attached license plate so that license plate indicia can be seen during darkness.

A single electrical connector provides electrical connections of lamp elements which perform a tail light function, a stop light function, a right turn signal light function, a left turn signal light function, and a back-up light function to a mating connector of a vehicle wiring harness to place the lamp elements of the tail lighting module in proper circuit relationships with the vehicle electrical system.

A general aspect of the claimed subject matter comprises a lighting assembly comprising: a lighting module having a first array of lamp elements to a first side of a central zone of the lighting module and a second array of lamp elements to a second side of the central zone; both the first array of lamp elements and the second array of lamp elements comprising at least one low intensity lamp element operable to cause the lighting module to present a low intensity brightness to an observer viewing the lighting module and at least one high intensity lamp element operable to cause the tail lighting module to present a high intensity brightness to an observer viewing the lighting module; and an electrical connector through which electric current is fed to operate the at least one low intensity lamp element of both the first array of lamp elements and the second array of lamp elements and the at least one high intensity lamp element of both the first array of lamp elements and the second array of lamp elements.

Another general aspect of the claimed subject matter comprises a vehicle comprising: a chassis frame having a cross-member extending between a first siderail and a second siderail; a lighting assembly fastened to the cross-member, the lighting assembly comprising a lighting module having a first array of lamp elements to a first side of a central zone of the lighting module, a second array of lamp elements to a second side of the central zone, and an electrical connector having terminal pins connected to the first array of lamp elements and to the second array of lamp elements, each array comprising at least one low intensity lamp element operable to cause a low intensity brightness to be presented to an observer viewing the lighting module and at least one high intensity lamp element operable to cause a high intensity brightness to be presented to an observer viewing the lighting module; and an electrical system for conducting electric current from a source in the vehicle to terminal pins of the electrical connector for operating the at least one low intensity lamp element of each array and the at least one high intensity lamp element of each array.

### BRIEF DESCRIPTION OF THE DRAWINGS

FIG. 1 is an elevation view of a tail lighting assembly looking toward a rear of a chassis frame cross-member to which the module is fastened.

FIG. 2 is a perspective view of the tail lighting assembly looking from the upper right at one side of the cross-member.

FIG. 3 is a rear view of the chassis frame cross member by itself.

FIG. 4 is a bottom view of the tail lighting assembly by itself.

FIG. 5 is a view in the direction of arrows 5-5 in FIG. 4.

FIG. 6 is a view in the direction of arrows 6-6 in FIG. 4.

FIG. 7 is a view in the direction of arrows 7-7 in FIG. 4.

FIG. 8 is a schematic view of one terminal configuration of an electrical connector of the tail lighting assembly.

FIG. 9 is a schematic view of a different terminal configuration for the electrical connector.

### DETAILED DESCRIPTION

A lighting assembly 22 described herein is capable of adaptation to any desired implementation, and is not limited to the illustrated embodiments. For instance, the lighting assembly can have any suitable orientation, such as horizontal, vertical, angular, curved or disjointed. Different embodiments of lighting assembly 22 may comprise multiple sections, may be rigid or may be flexible, allowing the lighting assembly 22 to conform to geometry of a support surface. To facilitate understanding, the lighting assembly 22 is discussed below with respect to an embodiment suited for application at a rear of a land vehicle.

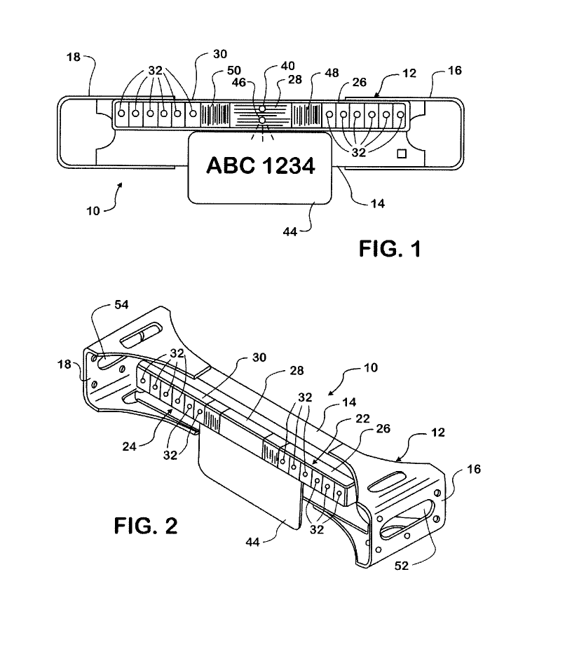

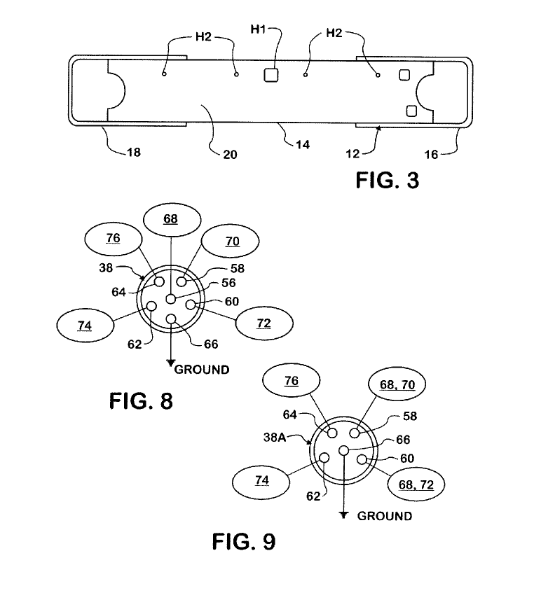

FIGS. 1, 2, and 3 show a portion of a vehicle 10 comprising a chassis frame 12 having a cross-member 14 extending between a first or right siderail 16 and a second or left siderail 18. Cross-member 14 has a rear face 20. A lighting assembly 22 is fastened to cross-member 14 in covering relation to an upper portion of rear face 20.

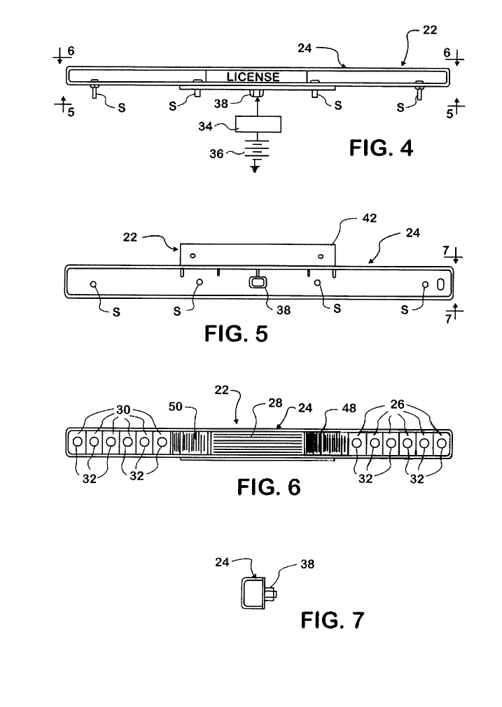

Lighting assembly 22 is shown by itself in FIGS. 4-7 and comprises a lighting module 24 having a back face disposed against cross-member rear face 20. Lighting module 24 comprises a first array 26 of lamp elements to a first or right side of a central zone 28 of the lighting module and a second array 30 of lamp elements to a second or left side of central zone 28. Arrays 26, 30 and central zone 28 face away from the module's back face.

Each array 26, 30 comprises lamp elements 32. At least one lamp element of each array is a low intensity lamp element operable to cause a low intensity brightness of light, colored red in one embodiment, to be presented to an observer viewing lighting module 24, and at least one lamp element of each array is a high intensity lamp element operable to cause a high intensity brightness of light, colored red in one embodiment, to be presented to an observer viewing lighting module 24.

An electrical system 34 in vehicle 10 conducts electric current from a source 36 in the vehicle through terminal pins (to be described in reference to FIG. 8) of an electrical connector 38 of lighting module 24 to operate low intensity lamp elements and high intensity lamp elements of each array 26, 30. Electrical connector 38 fits into and through a through-hole H1 in cross-member 14. Fastening of lighting module 24 to cross-member 14 comprises threaded studs S which extend from the module's back face to pass through through-holes H2 in cross-member 14 and nuts (not visible in the views of FIGS. 1 and 2) which are threaded onto the studs and tightened against cross-member 14.

Central zone 28 comprises at least one lamp element 40 (FIG. 1) operable to emit light which appears colorless to an observer viewing lighting module 24. The at least one lamp element 40 is connected to a terminal pin of electrical connector 38.

Lighting assembly 22 comprises a mounting 42 which is exterior of lighting module 24 below central zone 28 and to which a vehicle license plate 44 is fastened. Central zone 28 also comprises at least one lamp element 46 (FIG. 1) operable to shine colorless light on license plate 44.

Central zone 28 is separated from first array 26 by a first or right optical reflector zone 48 and from second array 30 by a second or left optical reflector zone 50.

A low intensity lamp element 32 is a farmost lamp element of first array 26 to the first or right side of central zone 28 and is visible from a first or right side of chassis frame 12 through a first or right open area 52 of the chassis frame. A low intensity lamp element 32 of second array 30 is a farmost lamp element of second array 30 to the second or left side of central zone 28 and is visible from a second or left side of chassis frame 12 through a second or left open area 54 of the chassis frame.

FIG. 8 shows electrical connector 38 to comprise a first terminal pin 56, a second terminal pin 58, a third terminal pin 60, a fourth terminal pin 62, a fifth terminal pin 64, and a sixth terminal pin 66. A first high intensity lamp element 32 of first array 26 and a first high intensity lamp element 32 of second array 30 are connected to first terminal pin 56. A second high intensity lamp element 32 of first array 26 is connected to second terminal pin 58. A second high intensity lamp element 32 of second array 30 is connected to third terminal pin 60. At least one low intensity lamp element 32 of first array 26, at least one low intensity lamp element 32 of second array 30, and a first lamp element 46 of the at least one lamp element of central zone 28 are connected to fourth terminal pin 62. A second lamp element 40 of the at least one lamp element of central zone 28 is connected to fifth terminal pin 64. Sixth terminal pin 66 provides a ground connection for all lamp elements.

Electrical system 34 comprises a first circuit 68 for issuing a stop signal to first terminal pin 56, a second circuit 70 for issuing a right turn signal to second terminal pin 58, a third circuit 72 for issuing a left turn signal to third terminal pin 60, a fourth circuit 74 for issuing a light signal to fourth terminal pin 62, and a fifth circuit 76 for issuing a back-up signal to fifth terminal pin 64.

When a brake pedal is depressed and operates a stop lamp switch, voltage is applied to first terminal pin 56 causing high intensity red stop lamp illumination of some of the lamp elements of arrays 26, 30 to signal stopping of the vehicle.

When a right turn signal switch is turned on, voltage is applied to second terminal pin 58 causing flashing of other high intensity lamp elements of array 26, thereby signaling intent to steer the vehicle to the right.

When a left turn signal switch is turned on, voltage is applied to third terminal pin 60 causing flashing of other high intensity lamp elements of array 30, thereby signaling intent to steer the vehicle to the left.

When a headlamp switch or a running lamp switch is operated, voltage is applied to fourth terminal pin 62 causing low intensity red illumination (lamp illumination) of arrays 26, 30 and colorless light illumination of license plate 44 by lamp element 46.

When a back-up switch is turned on by placement of the vehicle drivetrain in a reverse drive gear, voltage is applied to fifth terminal pin 64 causing colorless light illumination (back-up illumination) of central zone 28 by lamp element 40.

FIG. 9 shows an electrical connector 38A having only terminal pins 58, 60, 62, 64, and 66 for a lighting module 24 whose high intensity lamp elements in each array 26, 30 can provide both turn and stop signals due to the particular circuit arrangement of the stop lamp switch and the turn signal switches in the vehicle.

Using light emitting diodes (LEDs) for lamp elements 32 can provide proper degrees of lamp brightness with less current than incandescent lamps of comparable brightness. The inclusion of arrays 26, 30 in a single module and the use of a single electrical connector 38, 38A can facilitate mounting on a vehicle and connection with vehicle circuits.

What is claimed is:

1. A lighting assembly comprising:
a lighting module having a first array of lamp elements to a first side of a central zone of the lighting module and a second array of lamp elements to a second side of the central zone;
both the first array of lamp elements and the second array of lamp elements comprising at least one low intensity lamp element operable to cause the lighting module to present a low intensity brightness to an observer viewing the lighting module and at least one high intensity lamp element operable to cause the lighting module to present a high intensity brightness to an observer viewing the lighting module; and
an electrical connector through which electric current is fed to operate the at least one low intensity lamp element of both the first array of lamp elements and the second array of lamp elements and the at least one high intensity lamp element of both the first array of lamp elements and the second array of lamp elements.

2. The lighting assembly set forth in claim 1 in which the central zone comprises at least one lamp element operable to emit light which appears colorless to an observer viewing the lighting module.

3. The lighting assembly set forth in claim 2 in which the at least one low intensity lamp element of both the first array of lamp elements and the second array of lamp elements is operable to cause low intensity light to appear as low intensity red light to an observer viewing the lighting module, and the at least one high intensity lamp element of both the first array of lamp elements and the second array of lamp elements is operable to cause high intensity light to appear as high intensity red light to an observer viewing the lighting module.

4. The lighting assembly set forth in claim 2 comprising a mounting exterior of the lighting module below the central zone and a license plate fastened to the mounting, and in which the at least one lamp element of the central zone is operable to shine colorless light on the license plate.

5. The lighting assembly set forth in claim 3 in which the central zone is separated from the first array of lamp elements by a first optical reflector zone and from the second array of lamp elements by a second optical reflector zone.

6. The lighting assembly set forth in claim 3 in which a low intensity lamp element of the first array of lamp elements is a farmost lamp element of the first array of lamp elements from the central zone and a low intensity lamp element of the second array of lamp elements is a farmost lamp element of the second array of lamp elements from the central zone.

7. A vehicle comprising:
a chassis frame having a cross-member extending between a first siderail and a second siderail;
a lighting assembly fastened to the cross-member;
the lighting assembly comprising a lighting module having a first array of lamp elements to a first side of a central zone of the lighting module, a second array of lamp elements to a second side of the central zone, and an electrical connector having terminal pins connected to the first array of lamp elements and to the second array of lamp elements;
each array comprising at least one low intensity lamp element operable to cause a low intensity brightness to be presented to an observer viewing the lighting module and at least one high intensity lamp element operable to cause a high intensity brightness to be presented to an observer viewing the lighting module; and
an electrical system for conducting electric current from a source in the vehicle to terminal pins of the electrical connector for operating the at least one low intensity lamp element of each array and the at least one high intensity lamp element of each array.

8. The vehicle set forth in claim 7 in which the central zone comprises at least one lamp element operable to emit light which appears colorless to an observer viewing the lighting module.

9. The vehicle set forth in claim 8 in which the at least one low intensity lamp element of both the first array of lamp elements and the second array of lamp elements is operable to cause the low intensity light to appear as low intensity red light to an observer viewing the lighting module, and the at least one high intensity lamp element of both the first array of lamp elements and the second array of lamp elements is operable to cause the high intensity light to appear as high intensity red light to an observer viewing the lighting module.

10. The vehicle set forth in claim 9 comprising a mounting exterior of the lighting module below the central zone and a license plate fastened to the mounting, and in which the at least one lamp element of the central zone is operable to shine colorless light on the license plate.

11. The vehicle set forth in claim 9 in which the central zone is separated from the first array of lamp elements by a first optical reflector zone and from the second array of lamp elements by a second optical reflector zone.

12. The vehicle set forth in claim 9 in which a low intensity lamp element of the first array of lamp elements is a farmost lamp element of the first array of lamp elements from the central zone and is visible from a first side of the chassis frame through a first open area of the chassis frame, and in which a low intensity lamp element of the second array of lamp elements is a farmost lamp element of the second array of lamp elements from the central zone and is visible from a second side of the chassis frame through a second open area of the chassis frame.

13. The vehicle set forth in claim 7 in which the electrical system comprises a first circuit for issuing a stop signal to a first terminal pin of the electrical connector, a second circuit for issuing a first turn signal to a second terminal pin of the electrical connector, a third circuit for issuing a second turn signal to a third terminal pin of the electrical connector, and a fourth circuit for issuing a light signal to a fourth terminal pin of the electrical connector, and in which a first high intensity lamp element of both the first array of lamp elements and the second array of lamp elements is connected to the first terminal pin of the electrical connector, a second high intensity lamp element of the first array of lamp elements is connected to the second terminal pin of the electrical connector, a second high intensity lamp element of the second array of lamp elements is connected to the third terminal pin of the electrical connector, and a low intensity lamp element of both the first array of lamp elements and the second array of lamp elements is connected to the fourth terminal pin of the electrical connector.

14. The vehicle set forth in claim 13 in which the central zone comprises at least one lamp element operable to emit light which appears colorless to an observer viewing the lighting module, and the electrical system comprises a fifth circuit for issuing a back-up signal to a fifth terminal pin of the electrical connector to which the at least one lamp element of the central zone is connected.
